(19) United States
(12) Patent Application Publication
(10) Pub. No.: US 2007/0226461 A1
(43) Pub. Date: Sep. 27, 2007

(54) Reverse polish notation device for handling tables, and electronic integrated circuit including such a processing device

(75) Inventors: Sylvain Garnier, Nantes (FR); Mickael Le Dily, La Chapelle-Sur-Erdre (FR); Frederic Demange, Nantes (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Atmel Nantes SA, Nantes Cedex 3 (FR)

(21) Appl. No.: 11/657,392

(22) Filed: Jan. 24, 2007

(30) Foreign Application Priority Data
Jan. 24, 2006 (FR) 06/00655

(51) Int. Cl. G06F 12/00; G06F 9/30

(52) U.S. Cl. 712/202

(57) ABSTRACT

The disclosure relates to a reverse Polish notation processing device making it possible to execute a set of instructions and implementing management of a stack whose size is variable. The device includes a storage device including a random access memory; a device for managing a stack pointer, which is a physical address, in said random access memory, associated with a reference stage of the stack; and a device for managing reference element pointer(s), which is a physical address, in said random access memory, associated with one reference element among elements of a given table contained in the stack. The processing device can execute at least one table-handling instruction with respect to the reference element pointer(s).

### FIELD OF THE DISCLOSURE

The field of the disclosure is that of electronic circuits.

More precisely, the disclosure relates to a reverse Polish notation (or RPN) processing device of the type enabling the execution of instructions relating to the handling of tables.

A processing device such as this conventionally includes a stack of variable size, managed according to a “last in, first out” (or LIFO) mode with stack pointers. This stack makes it possible to store table elements on stages. A table element, for example, is an octet.

The processing device according to the disclosure has numerous applications, e.g., such as the implementation of n-dimensional matrix operations, with n 1.

The disclosure applies in particular, but not exclusively, to the processing of compressed audio streams, e.g., in MP3 format (MPEG-1/2 Audio Layer 3), WMA (Windows Media Audio), etc.

### BACKGROUND OF THE DISCLOSURE

Reverse Polish notation processing devices are currently software-implemented, e.g., in a microprocessor. Such processing devices can be programmed in Java, C, C++ language, etc.

As an example, the Hewlett Packard Company has developed a calculator equipped with a postfix programming language called reverse Polish lisp (or RPL), according to which a stack is software-implemented using a Saturn 4-bit microprocessor (marketed by Motorola). This “software stack” is a stack of pointers pointing to objects that are conventionally represented by variable-sized groups of words managed by an operating system. The operating system (i.e., software) makes it possible to carry out operations on objects.

Although the software implementation of a reverse Polish notation processing device represented significant progress, this known technique nevertheless has the disadvantages of being costly in terms of resources (memory, CPU, etc.) and of having long computing times.

Another major disadvantage of this known technique lies in the fact that it requires a software overlay.

Furthermore, the inventors of the present disclosure observed that the use of an implementation such as this could lead to high electricity consumption.

In addition, as concerns tables (also called matrices), the solution proposed by Hewlett Packard consists in assimilating a table to an object. An object, for example, is an n-dimensional matrix. It is important to note that each table that is defined by the operating system is a variable-sized object and occupies a single stage in the stack. Thus, with a software implementation such as this, the stack does not contain table elements, but tables, which renders the calculations involving these tables more complex. As a matter of fact, it is the operating system that must manage the calculations involving the table elements.

### SUMMARY OF THE DISCLOSURE

An embodiment of the disclosure is directed to a reverse Polish notation processing device, making it possible to execute a set of instructions and implementing management of a stack whose size is variable.

The device includes:
storage means including a random access memory;
means for managing a stack pointer, which is a physical address, in said random access memory, associated with a reference stage of the stack, each stage of the stack being such that when the stack moves it occupies a fixed position in the stack but is associated with a physical address in said random access memory, which varies;
means for managing at least one reference element pointer, which is a physical address, in said random access memory, associated with one reference element among elements of a given table contained in the stack, said reference element being such that when the stack moves it can be located at different stages of the stack but is associated with a physical address that does not vary.

The device can execute at least one table-handling instruction with respect to said at least one reference element pointer.

Thus, the device is based on a completely novel and inventive approach for managing a stack implemented in a random access memory. As a matter of fact, the device is based upon an addressing mechanism, implementing a first pointer that permanently points to a physical address (in random access memory) associated with a reference stage, so as to control the movements of the contents of the stages of the stack in relation to the reference stage, and a second pointer permanently pointing to a physical address (in random access memory) (so-called root address) containing a reference element, whereby the table-handling instructions are executed with respect to the root address.

According to one advantageous aspect of the disclosure, said means for managing at least one reference element pointer include means for managing an absolute reference element pointer, which is a physical address, in said random access memory, associated with an absolute reference element among the elements of a given table contained in the stack.

In one embodiment of the invention, said means for managing at least one reference element pointer include means for managing a relative reference element pointer, which is a physical address, in said random access memory, associated with a relative reference element among the elements of a given table contained in the stack.

Another embodiment relates to an electronic integrated circuit including a processing device as cited above. An electronic integrated circuit is understood to mean, in particular, but not exclusively, a processor, a microprocessor, a controller, a microcontroller or a coprocessor.

### BRIEF DESCRIPTION OF THE DRAWINGS

Other characteristics and advantages will become apparent upon reading the following description of an embodiment of the invention, given for non-limiting, illustrative purposes, and from the appended drawings in which:

FIG. 1 is a logic diagram of a particular embodiment of the device for processing table-handling instructions;

FIG. 2 is a logic diagram of a particular embodiment of the device for processing arithmetic and data-handling instructions;

FIG. 3 is a simplified logic diagram of a particular embodiment of a mechanism for executing a CELLREPL(X)-type instruction;

FIG. 4 is a simplified logic diagram of a particular embodiment of a mechanism for executing a GETCELLREL(X)-type instruction;

FIG. 5 is an exemplary representation of the movement of the contents of the stages of a LIFO stack of a processing device; and

FIG. 6 is an exemplary representation of the movement of the memory plane and of the computing registers of a processing device.

### DETAILED DESCRIPTION OF ILLUSTRATIVE EMBODIMENTS

Description of one Particular Embodiment

In all of the figures of this document, identical elements or signals are designated by the same alphanumeric reference.

The disclosure thus relates to a hardware architecture for a reverse Polish notation processing device including physical table pointers, giving it the capability, on the one hand, of optimally managing a stack capable of containing table elements, and, on the other hand, of executing handling instructions for these table elements, in particular for performing matrix operations. The basic principle of an embodiment of the invention is based on an addressing technique making it possible to assign a constant physical address to each table element. Thus, the disclosure proposes to implement a physical pointer that contains the address of a specific table element (constant address), so as to obtain an absolute marker that does not undergo the variations in the stack.

Furthermore, in one of its embodiments, the disclosure proposes to manage a LIFO stack, whose first stages are implemented in a cache memory and the other stages in a random access memory. To accomplish this, the processing device according to an embodiment includes means for managing the content overflows of the stages from the cache memory towards the random access memory, and vice-versa.

For non-limiting, illustrative purposes, the remainder of the description will deal with the particular case of a “microprocessor/coprocessor” interfacing wherein an interfacing device (generally called FIFO for “first in, first out”) is placed between a microprocessor (generally called a CPU, for “central processing unit”) and a coprocessor, in which the processing device is (hardware) implemented. It is clear that an embodiment of the invention can be implemented in an 8-bit, 16-bit, 32-bit, etc. type coprocessor.

It is recalled that, in a configuration such as this, the coprocessor processes information flows in order to reduce the load of the microprocessor. As a matter of fact, the microprocessor transmits instructions (i.e., variable-sized groups of words), via the interfacing device, to the coprocessor, in order for it to execute them.

For the sake of simplifying the description, the remainder of this document will be limited to describing the particular case of a hardware implementation, wherein the reference stage of the stack is the first stage of the stack, and for each of the two first stages of the stack, referenced as Stage 0 and Stage 1, respectively, the content of the stage is stored in the cache memory, and for each of the other stages of the stack, the content of the stage is stored in the random access memory.

Those skilled in the art will easily extend this teaching to a greater number of stages whose contents can be stored in the cache memory.

General Description of the Processing Device

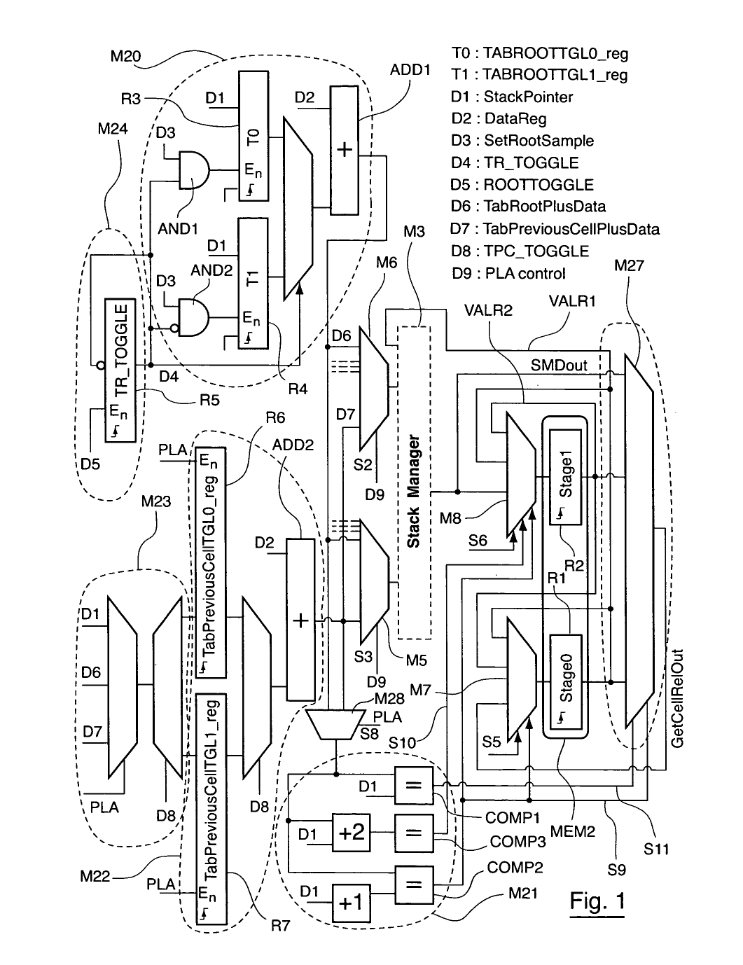

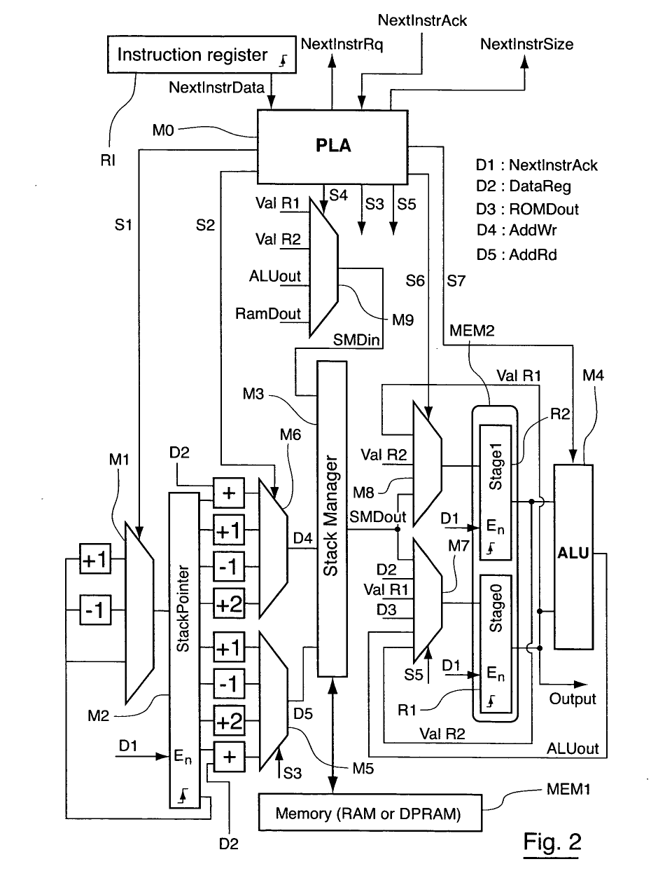

A processing device according to a preferred embodiment of the disclosure will now be described in relation to FIGS. 1 and 2.

In this embodiment, the processing device is loaded into a coprocessor and includes two families of means:
a first family of means (FIG. 1) dedicated to the execution of table-handling instructions and including means M20, M24, M22, M23 and M25 for managing a reference element pointer which is a physical address, in the random access memory, associated with a specific reference element contained in the stack. The reference element being such that, when the stack moves, it can be located at various stages of the stack but is associated with a physical address that does not vary. As will be seen subsequently, these means enable the device to execute one (of the) table-handling instruction(s), with respect to the reference element pointer. The means M20, M24, M22, M23 and M25 for managing the reference element pointer themselves include:
   means M20 and M24 for managing an absolute reference element pointer, which is a physical address, in the random access memory, associated with a specific absolute reference element contained in the stack;
   means M22, M23 and M25 for managing a relative reference element pointer, which is a physical address, in the random access memory, associated with a specific relative reference element contained in the stack;
a second family of means (FIG. 2) dedicated to the execution of arithmetic and data-handling instructions, and including:
   storage means including a random access memory RAM (MEM1)and a cache memory (MEM2);
   means M0, M1 and M2 for managing a stack pointer, which is a physical address, in the random access memory, associated with a reference stage of the stack. Each stage of the stack being such that, when the stack moves, it occupies a fixed position in the stack but is associated with a physical address, in the random access memory, which varies. In the embodiment shown, the reference stage of the stack is the first stage Stage 0 of the stack;
means M0, M5, M6, M9, M3, M7, M8, M21 and M27 for managing the contents of the stages of the stack, with relation to the stack pointer such that, for each of the two first stages of the stack Stage 0 and Stage 1, the content of the stage is stored in the cache memory, and for each of the other stages of the stack, the content of the stage is stored in the random access memory, at the physical address associated with the stage. As will be seen subsequently, these means make it possible to manage content overflows from the cache memory towards the random access memory, and vice-versa.
   Detailed Description of the Means or Device(s) for Executing Table-handling Instructions Specific to an Embodiment of the Invention

The means for managing the absolute reference element pointer and the means for managing the relative reference element pointer specific to an embodiment of the invention will now be described in relation to FIG. 1.

In the embodiment shown, the means for managing the absolute reference element pointer include:
two registers R3 (Tabroottg10_reg) and R4 (Tabroottg11_reg) each associated with an absolute access table, called first registers. Each first register contains the current value of the absolute reference element pointer (i.e., the current physical address in memory of the stage of the stack containing the absolute reference element) for the absolute access table with which it is associated, and has an input receiving the current value (StackPointer) of the stack pointer. As shown, each first register is activated by an activation signal (En) assuming an active state (En=1) when the current instruction is an instruction (e.g., of the SETROOT type) involving a change in the absolute reference element;
first means for selecting M24 one table among the two aforesaid absolute access tables (associated with the first registers). These first selection means include a register R5 that is activated by an activation signal (En) assuming an active state (En=1) when an instruction of the “ROOTTOGGLE” type is executed (ROOTOGGLE=1). This register R5 delivers a signal TR_TOGGLE at its output, which changes value (“1” or “0”) at each execution of the instruction “ROOTTOGGLE.” The signal TR_TOGGLE is sent towards the first inputs of two “AND” gates AND1 and AND2, whose second inputs each receive a signal indicating that a change in the absolute reference element is requested (SETROOT=1). As shown, the output of the first “AND” gate AND1 is connected to the activation input (En) of the first register R3 (Tabroottg10_reg) associated with the first absolute access table, and the output of the second “AND” gate AND2 is connected to the activation input (En) of the second register R4 (Tabroottg11_reg) associated with the second absolute access table. Thus, during execution of the instruction “SETROOT” (SETROOT=1):
   if TR_TOGGLE is equal to “0,” then the first register R3 (Tabroottg10_reg) associated with the first absolute access table is selected, so as to update this register R3 (Tabroottg10_reg) with the current value (StackPointer) of the stack pointer;
   if TR_TOGGLE is equal to “1,” then the second register R4 (Tabroottg11_reg) associated with the second absolute access table is selected, so as to update this register R4 (Tabroottg11_reg) with the current value (StackPointer) of the stack pointer.

It is noted that the execution of the instruction “ROOTTOGGLE” can have an impact on other types of instructions, in particular, but not exclusively, the instructions “GETCELL” and “CELLREPL.” More precisely, “ROOTTOGGLE” makes it possible to change the reference of the first cell of a table viewed by “GETCELL” and “CELLREPL.” As a matter of fact, if TR_TOGGLE is equal to “0,” then the two instructions “GETCELL” and “CELLREPL” operate from the cell pointed to by Tabroottg10_reg (i.e., the register associated with the first absolute access table), otherwise they operate from the cell pointed to by Tabroottg11_reg (i.e., the register associated with the second absolute access table);
first means of addition making it possible, for a table selected from among the two aforesaid absolute access tables, to determine, from the absolute reference element, the physical address in memory (TabRootPlusData) of the stage of the stack whose content is the Xth (also called DataRegth) element of the table selected. These first means of addition include an adder ADD1 receiving, at a first input, the current value of the absolute reference element pointer (for the selected table) and, at a second input, a number of units DataReg indicated in an operand word of the current instruction. The adder ADD1 thus delivers at its output the physical address in memory of the DataRegth cell of the selected table, corresponding to the current value of the absolute reference element pointer (i.e., the current physical address in memory of the stage of the stack containing the absolute reference element) incremented by the number of units DataReg.

In this embodiment, the means for managing the relative reference element pointer include:
two registers R6 (TabPreviousCellTg10_reg) and R7 (TabPreviousCellTg11_reg) each associated with a relative access table, called second registers. Each second register contains the current value of the relative reference element pointer (i.e., the current physical address in memory of the stage of the stack containing the relative reference element) for the relative access table with which it is associated, and has an input receiving one of the three following signals based on the current instruction, e.g.:
   if the current instruction is of the “SETROOT” type, then the input receives the current value (StackPointer) of the stack pointer;
   if the current instruction is of the “GETCELL” type, then the input receives the current value of the absolute reference element incremented by the number of units DataReg, called TabRootPlusData;
   if the instruction is of the “GETCELLREL” type, then the input receives the current value of the relative reference element pointer incremented by the number of units DataReg, called TabPreviousCellPlusData.

As shown, each second register is activated by an activation signal (En) assuming an active state (En=1) when the current instruction is an instruction (e.g., of the SETROOT, GETCELL or GETCELLREL type) involving a change in the relative reference element;
second means for selecting M25 one table from among the two aforesaid relative access tables (associated with the second registers). These second selection means include a register R8 that is activated by an activation signal (En) assuming an active state (En=1) when an instruction of the “GCR_TOGGLE” type is executed (GCR_TOGGLE=1). This register R8 delivers, at its output, a signal TPC_TOGGLE which changes value (“1” or “0”) at each execution of the instruction “GCR_TOGGLE.” Thus, during execution of the instruction “GCR_TOGGLE” (GCR_TOGGLE=1):
   if TPC_TOGGLE is equal to “0,” then the first register R6 (TabPreviousCellTg10_reg) associated with the first relative access table is selected, so as to update this register R6 (TabPreviousCellTg10_reg) with one of the three aforesaid signals StackPointer, TabRootPlusData or TabPreviousCellPlusData, based on the current instruction;
   if TPC_TOGGLE is equal to “1,” then the second register R7 (TabPreviousCellTg11_reg). associated with the second relative access table is selected, so as to update this register R7 (TabPreviousCellTg11_reg) with one of the three aforesaid signals StackPointer, TabRootPlusData or TabPreviousCellPlusData, based on the current instruction.

It is noted that the execution of the instruction “GCR_TOGGLE” can have an impact on other types of instructions, in particular, but not exclusively, the instruction “GETCELLREL.” More precisely, “GCR_TOGGLE” makes it possible to change the reference of the first cell of a table viewed by “GETCELLREL.” As a matter of fact, if TPC_TOGGLE is equal to “0,” then the instruction “GETCELLREL” operates from the cell pointed to by TabPreviousCellTg10_reg (i.e., the register associated with the first relative access table), otherwise it operates from the cell pointed to by TabPreviousCellTg11_reg (i.e., the register associated with the second relative access table);
second means of addition making it possible, for a table selected from among the two aforesaid relative access tables, to determine, from the relative reference element, the physical address in memory (TabPreviousCellPlusData) of a stage of the stack whose content is the DataRegth element of the selected table. These second means of addition include an adder ADD2 receiving, at a first input, the current value of the relative reference element pointer (for the selected table) and, at a second input, the number of units DataReg. The adder ADD2 delivers, at its output, the physical address in memory of the DataRegth cell of the selected table, corresponding to the current value of the relative reference element pointer (i.e., the current physical address in memory of the stage of the stack containing the relative reference element) incremented by the number of units DataReg.
   Detailed Description of the Means for Executing Arithmetic and/or Data-handling Instructions Specific to an Embodiment of the Invention

The means for managing the stack pointer and the means for managing the contents of the stages of the stack specific to an embodiment of the invention will now be described in relation to FIG. 2.

In the illustrated embodiment, the means for managing the stack pointer include:
a first multiplexer M1 having three inputs receiving, respectively: the current value (StackPointer) of the stack pointer, the current value of the stack pointer incremented by one unit (StackPointer+1), and the current value of the stack pointer decremented by one unit (StackPointer-1). This first multiplexer M1 delivers at its output one of the three input values of a current instruction, on the basis of a first control signal S1 taking into account the balance on the stack, +1, −1 or 0. In other words, the first multiplexer M1 provides the next physical address in memory of the first stage Stage 0 of the stack;
a register M2, called the third register, containing the current value of the stack pointer (i.e., the current physical address in memory of the first stage of the stack), and whose input is connected to the output of the first multiplexer M1. This third register M2 is activated by an activation signal (En) indicating that a next instruction is ready (NextInstrAck=1).

In order to manage the contents of the stages of the stack, the processing device includes:
means for determining the next write address AddWr in the random access memory RAM. These determination means include a second multiplexer M6 that has six inputs: the first input receiving the current value (StackPointer) of the stack pointer incremented by the number of units DataReg (indicated in the operand word of the current instruction), the second input receiving the current value of the stack pointer incremented by one unit (StackPointer+1), the third input receiving the current value of the stack pointer incremented by two units (StackPointer+2), the fourth input receiving the current value of the stack pointer decremented by one unit (StackPointer−1), the fifth input receiving the value TabRootPlusData, i.e., the current value of the absolute reference element pointer incremented by the number of units DataReg, and the sixth input receiving the value TabPreviousCellPlusData, i.e., the current value of the relative reference element pointer incremented by the number of units DataReg. The second multiplexer M6 delivers at its output one of the input values, on the basis of a second control signal S2, which is based on the current instruction;
means for determining the next read address AddrRd in the random access memory RAM. These determination means include a third multiplexer M5 that has six inputs: the first input receiving the current value of the stack pointer incremented by the number of units DataReg, the second input receiving the current value of the stack pointer incremented by one unit, the third input receiving the current value of the stack pointer incremented by two units, the fourth input receiving the current value of the stack pointer decremented by one unit, the fifth input receiving the value TabRootPlusData, i.e., the current value of the absolute reference element pointer incremented by the number of units DataReg, and the sixth input receiving the value TabPreviousCellPlusData, i.e., the current value of the relative reference element pointer incremented by the number of units DataReg. The third multiplexer MS delivers at its output one of the input values, on the basis of a third control signal S3, which is based on the current instruction.

It is important to note that certain instructions make it possible to read or write data anywhere in the stack. The means for determining the next write AddWr or read AddrRd address according to an embodiment of the invention advantageously make it possible to calculate the physical address to be reached with respect to the current value of the stack pointer;
means for determining the next data to be written in the random access memory RAM. These means include a fourth multiplexer M9 that has four inputs receiving, respectively: the current content (ValR1) of the first stage Stage 0 of the stack (i.e., the content of the register R1), the current content (ValR2) of the second stage Stage 1 of the stack (i.e., the content of the register R2), data SMDout read in the random access memory RAM during execution of the current instruction, and data ALUout calculated during execution of the current instruction. The fourth multiplexer M9 delivers at its output one of the input values, on the basis of a fourth control signal S4, which is based on the current instruction;
means M21 for determining the side effects of the cache memory, making it possible to determine if the current value of the absolute or relative reference element pointer, incremented by the number of units DataReg, is a physical address, in the random access memory, associated with:
   a stage of the stack whose content is stored in the random access memory RAM;
   a stage of the stack whose content is stored in the cache memory (MEM2);
   a DataRegth stage of the stack whose content is stored in the random access memory.

These determination means M21 include:
a first comparator COMP 1, making it possible to make a comparison, on the one hand, between the current value of the absolute or relative reference element pointer, incremented by the number of units DataReg (TabRootPlusData or TabPreviousCellPlusData, respectively), and, on the other hand, the current value of the stack pointer (StackPointer);
a second comparator COMP2, making it possible to make a comparison, on the one hand, between the current value of the absolute or relative reference element pointer, incremented by the number of units DataReg (TabRootPlusData or TabPreviousCellPlusData, respectively), and, on the other hand, the current value of the stack pointer incremented by one unit (StackPointer+1);
a third comparator COMP3, making it possible to make a comparison, on the one hand, between the current value of the absolute or relative reference element pointer, incremented by the number of units DataReg (TabRootPlusData or TabPreviousCellPlusData, respectively), and, on the other hand, the current value of the stack pointer incremented by one unit (StackPointer+2).

These determination means M21 further include a fifth multiplexer M28 that has two inputs: the first input receiving the current value of the absolute reference element pointer incremented by the number of units DataReg (TabRootPlusData), and the second input receiving the current value of the relative reference element pointer incremented by the number of units DataReg (TabPreviousCellPlusData). The fifth multiplexer M28 delivers at its output one of the input values, on the basis of a fifth control signal S8, which is based on the current instruction.

It is important to note that the table does not relate to the stack. As a matter of fact, its reference is a physical pointer. The means for determining the side effects of the cache memory test whether the physical address of the memory cell being accessed corresponds to data in cache or in the RAM memory space. If the data is in cache, the data at the corresponding physical address in memory is not valid, due to the fact that data is written in memory only when it leaves the cache;
means for determining the next value to be written in the cache memory for the content of the first stage. These determination means include a sixth multiplexer M7 that has six inputs: the first input receiving the current value (ValRI) of the content of the first stage Stage 0, the second input receiving the current value (ValR2) of the content of the second stage Stage 1, the third input receiving the value DataReg, the fourth input receiving the data SMDout, the fifth input receiving the data ALUout and the sixth input receiving a value (GetCellRelOut) delivered by means M27 for compensating for the side effects of the cache memory. The sixth multiplexer M7 delivers at its output one of the input values, on the basis of a sixth control signal S5, which is based on the current instruction, and/or a sixth central signal S9 delivered by the means M21 for determining the side effects of the cache memory, which indicates if the current value of the absolute or relative reference element pointer, incremented by the number of units DataReg, is equal to the current value of the stack pointer incremented by one unit (StackPointer+1).

It is important to note that the cache memory includes a register R1, called the fourth register, containing the current value (VALR1) of the content of the first stage Stage 0. The input of the fourth register is connected to the output of the sixth multiplexer M7. This fourth register is activated by an activation signal (En) indicating that the next instruction is ready (NextInstrAck=1);
means for determining the next value to be written in the cache memory for the content of the second stage Stage 1. These determination means include a seventh multiplexer M8 that has three inputs receiving, respectively: the current value of the content of the first stage Stage 0, the current value of the content of the second stage Stage 1, and the data SMDout. The seventh multiplexer M8 delivers at its output one of the input values, on the basis of:
   the seventh control signal S9 delivered by the means M21 for determining the side effects of the cache memory; and/or
   an eighth control signal S6, which is based on the current instruction; and/or
   a ninth control signal S10, delivered by the means M21 for determining the side effects of the cache memory, which indicates if the current value of the absolute or relative reference element pointer, incremented by the number of units DataReg, is equal to the current value of the stack pointer incremented by two units (StackPointer+2).

It is noted that the cache memory includes a register R2, called the fifth register, containing the current value (VALR2) of the content of the second stage Stage 1. The input of the fifth register is connected to the output of the seventh multiplexer M8. This fifth register is activated by an activation signal (En) indicating that a next instruction is ready (NextlnstrAck=1);
means for compensating for the side effects of the cache memory. These compensating means include an eighth multiplexer M27 that has three inputs: the first input receiving the current value (VaiR1) of the content of the first stage Stage 0, the second input receiving the current value (ValR2) of the content of the second stage Stage 1, and the third input receiving the data SMDout. The eighth multiplexer M27 delivers at its output one of the input values, on the basis of seventh and tenth control signals S9 and S11, delivered by the means M21 for determining the side effects of the cache memory. The eighth multiplexer M27 delivers at its output, for example:
   the current value (ValR1) of the content of the first stage Stage 0, if the tenth control signal S11 indicates that the current value of the absolute or relative reference element pointer, incremented by the number of units, is equal to the current value of the stack pointer (StackPointer);
   the current value (ValR2) of the content of the second stage Stage 1, if the seventh control signal S9 indicates that the current value of the absolute or relative reference element pointer, incremented by the number of units, is equal to the current value of the stack pointer incremented by one unit (StackPointer+1);
   the data SMDout, read in the random access memory during execution of the current instruction, if the seventh and tenth control signals S9 and S11 together indicate that the current value of the absolute or relative reference element pointer, incremented by the number of units DataReg, is equal to the current value of the stack pointer incremented by two units (StackPointer+2).

These means for compensating for the side effects of the cache memory are used during execution of the instructions “GETCELL” and “GETCELLREL,” in conjunction with means M21 for determining the side effects of the cache. When it is detected that a cell of a table being read is situated in cache, then the data pushed into the stack is the value of the cache, and not that coming from reading the random access memory RAM.

In an alternative embodiment, the eighth multiplexer M27 can be assigned an additional command via a signal generated by an instruction decoder M0 (e.g., a “PLA” for “Programmable Logic Array”). In order to optimise the consumption of electricity by the device of an embodiment of the invention, it is desirable to activate the multiplexer only during execution of the instructions “GETCELL” and “GETCELLREL.” In the case of executing instructions other than “GETCELL” and “GETCELLREL,” the multiplexer will remain in its off position, the output of this multiplexer then not being used.

In order to execute an operation, which is based on the current instruction, the processing device further includes a arithmetic calculation unit M4 having two inputs receiving, respectively: the current value of the first stage Stage 0 and the current value of the content of the second stage Stage 1. This arithmetic calculation unit M4 delivers at its output the data ALUout calculated with an arithmetic operator, e.g., an adder, subtractor, multiplier, etc., selected by an eleventh control signal S7.

As shown in FIG. 2, each control signal S1 to S8 is delivered by an instruction decoder M0, which processes the current instruction contained in the instruction register RI.

Set of Instructions

Presented in Appendix 1 are examples of table-handling instructions that can be executed by the processing device according to an embodiment of the invention. This Appendix forms an integral part of this description.

Instruction CELLREPL(X)

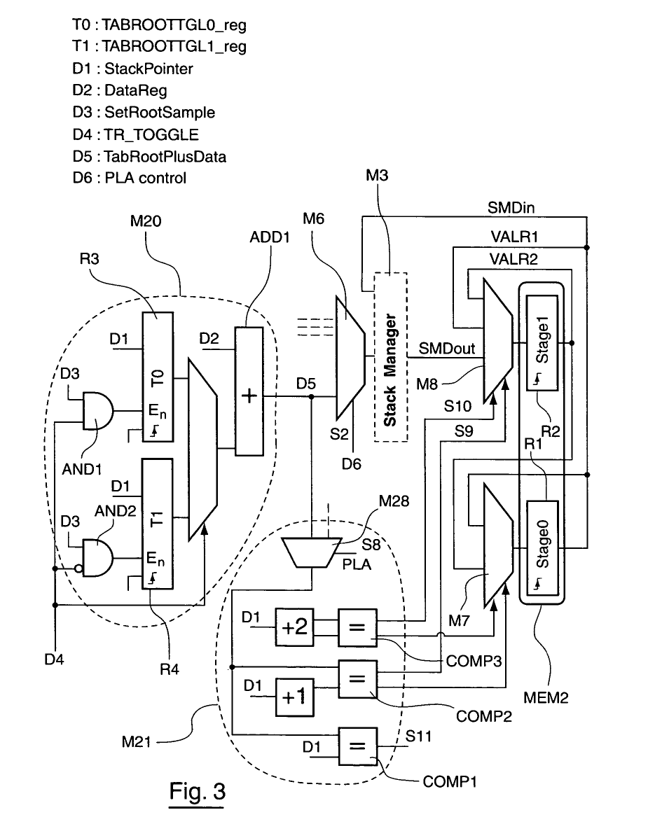

The hardware implementation of an instruction CELLREPL(X) will now be described in relation to FIG. 3, while indicating the state or action carried out by each means M0 to M27 of the processing device according to an embodiment of the invention.

This instruction makes it possible to replace the Xth element DataRegth of a table (selected by TR_TOGGLE), with respect to an absolute reference element, by an element contained in the first stage of the stack Stage 0 (R1). The element contained. in the first stage of the stack Stage 0 (R1) is absorbed, the balance on the stack is thus −1.

The instruction CELLREPL(X) is translated by the following sequence:
M0: decodes the instruction;
M4: quiescent state(no arithmetic operation, the ALU is not selected);
M7:
   if the means M21 for determining the side effects of the cache detect that the DataRegth cell of the table is Stagel (i.e., the second stage of the stack implemented in R2), then M7 selects Stage0 (R1);
   if the means M21 for determining the side effects of the cache detect that the DataRegth cell of the table is not Stagel (R2), then M7 selects Stagel (R2);
M1: selects the input corresponding to StackPointer+1 (balance −1 on the stack);
M2: resets itself at the next clock stroke, if the enable input of the register is at “1” (NextInstrAck=1);
M5: selects the input corresponding to the StackPointer+2 (the data going into Stage (R2) will be read);
M20: calculates the physical address of the DataRegth cell of the table selected by TR_TOGGLE;
M6: selects the output of the means M20, i.e., the physical address of the DataRegth cell of the table selected by TR_TOGGLE;
M21: tests whether the DataRegth cell of the table selected by TR_TOGGLE is Stagel or Stage2, in order to schedule the update of Stage0 (R1) and Stagel (R2);
M9: quiescent state;

M0: positions the memory enable “Me” and write enable “We” inputs of
M3 at “1” and “0,” respectively, thus there will be a reading of the future value of Stagel (R2);
M8: (it is important to note that the following selections are made for the case of the instruction CELLREPL)
   if the equality comparator at “StackPointer+1” of M21 presents “1” at its output, then M8 selects the input SMDout;
   if the equality comparator at StackPointer+2 of M21 presents “1” at its output, then M8 selects the input ValR2 (R2);
   if none of the equality comparators at “StackPointer+1” and at “StackPointer+2” are at “1”, the M8 selects the input SMDout;
M21: the input multiplexer of the comparators selects TabRootPlusData.
   Instruction GETCELLREL(X)

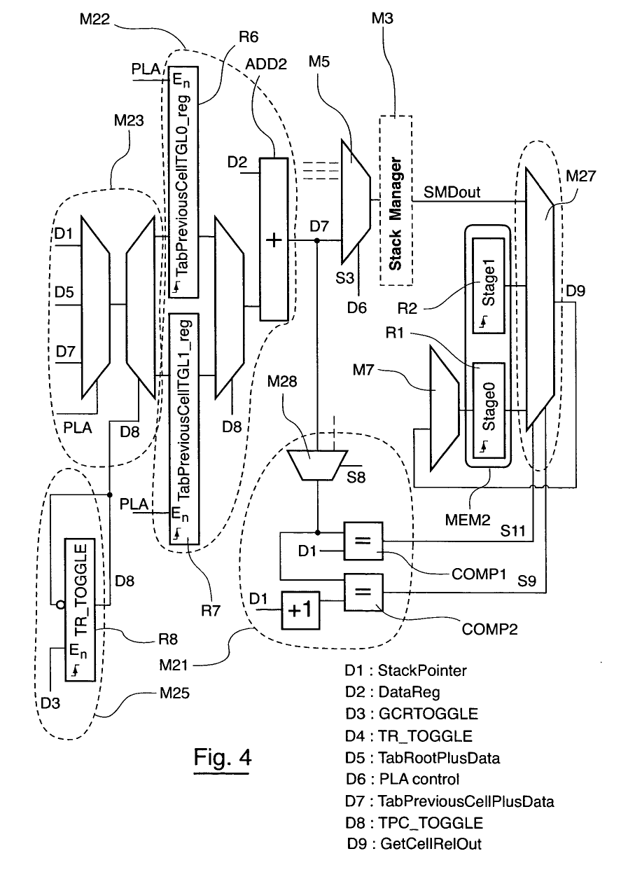

The hardware implementation of an instruction GETCELLREL(X) will now be described in relation to FIG. 4, while indicating the state or action carried out by each means M0 to M27 of the processing device according to an embodiment of the invention.

This instruction makes it possible to insert into the first stage of the stack the Xth element of a table (selected by ROOTTOGGLE), with respect to a relative reference element, i.e., following the last previously accessed element. It is noted that, upon each new access, the physical pointer containing the address of the last cell of the table accessed is re-updated. The balance on the stack is 1.

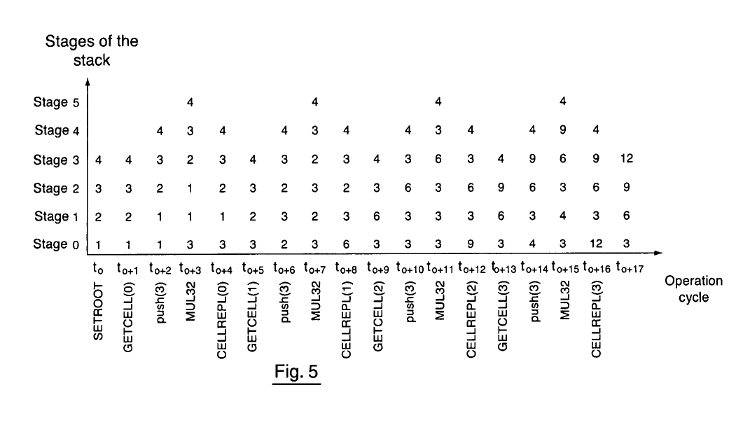

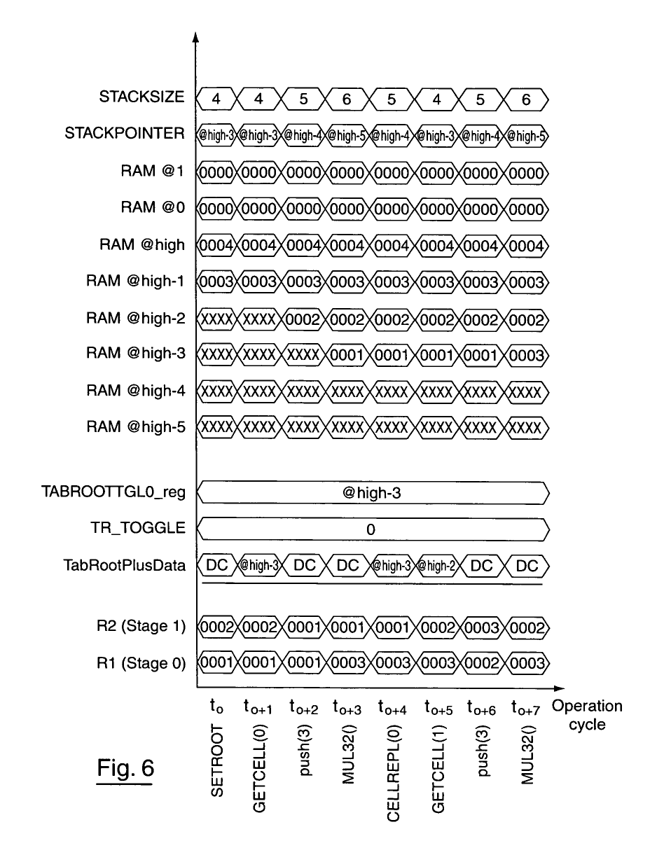

This instruction GETCELLREL(X) is translated by the following sequence:
M0: decodes the instruction;
M4: quiescent state (no arithmetic operation, the ALU is not selected);
M7: selects the output of the means for compensating for the side effects of the cache, named GetCellRelOut;
M1: selects the input corresponding to StackPointer−1 (balance+1 on the stack);
M2: resets itself at the next clock stroke, if the enable input of the register is at “1” (NextlnstrAck=1);
M5: selects the input corresponding to the output of the means M22 for determining the physical address of the TPCth cell of the table selected by TPC_TOGGLE: TabPreviousCellTGLx_reg+DataReg (this address relates to StackPointer);
M6: selects the input StackPointer+1, the physical cell corresponding to Stage1 in the memory plane must be updated with the data ValR2 of the register R2, which will itself be updated with the former value ValR1 of the register R1;
M9: quiescent state;
M0: positions the memory enable “Me” and write enable “We” inputs of M3 at “1,” thus there will be a reading at the address selected by M5 and a writing at the address selected by M6;
M8: selects the input ValR1 (R1);
M23: updates the register TabPreviousCellTGLx_reg with the value TabPreviousCellTGLx_reg+DataReg;
M21: the input multiplexer of the comparators selects TabPreviousCellPlusData;
M27:
   if the equality comparator at “StackPointer” of M21 presents “1” at its output, then M27 selects the input ValR1 (R1);
   if the equality comparator at “StackPointer+1” of M21 presents “1” at its output, then M27 selects the input ValR2 (R2);
   if none of the equality comparators at “StackPointer” and at “StackPointer+1” are at “1,” then M27 selects the SMDout.
      Discussion of an Example of the Movement of a LIFO Stack (FIG. 5), of a Memory Plane and of Computing Registers (FIG. 6)

FIG. 5 shows an example of the movement of a FIFO stack of a processing device according to an embodiment of the invention, for a particular matrix operation case according to the principle of reverse Polish notation. It is recalled that the structure of a LIFO stack is based on the principle that the last data added to the structure will thus be the first to be removed. As will be seen subsequently, the balance of an instruction on a stack is either zero, or 1 or −1.

In this particular case, it is desirable that the following matrix operation be carried out:

$$[ \begin{matrix}1 \\ 2 \\ 3 \\ 4\end{matrix} ] \times 3 = [ \begin{matrix}3 \\ 6 \\ 9 \\ 12\end{matrix} ]$$

Presented in Appendix 2 is an example of a programme in C language making it possible to implement the aforesaid matrix operation. This Appendix forms an integral part of this description.

As shown in FIG. 5, this matrix operation is translated by the following sequence: (it is assumed that at the moment t0, the first, second, third and fourth stages of the pile, referenced as Stage 0, Stage 1, Stage 2 and Stage 3, respectively, are loaded with the values “1,” “2,” “3” and “4,” respectively.
at the moment t0, an instruction “SETROOT” is generated. This instruction makes it possible to define an absolute reference element from among the elements of a given table;
at the moment t0+1, the instruction “SETROOT” is executed (the balance is 0), the one-dimensional table “[1 2 3 4]” is then defined and has the element positioned at the bottom of the stack as a reference element, i.e., the value “1” on Stage 0. At this same moment t0+1, an instruction “GETCELL(x)” is generated. This instruction makes it possible to insert into the bottom of the stack (Stage 0) the element of the table stored on the Xth stage of the stack in relation to the stage containing the reference element. As will be seen subsequently, for x=0 (GETCELL(0)), the element of the table stored on the 0 Stage of the, stack, in relation to the stage containing the reference element, is inserted into the bottom of the stack (Stage 0), i.e., the reference element itself is inserted on Stage 0;
at the moment t0+2, the instruction “GETCELL(0)” is executed, the value “1” (i.e., the element stored on “Stage 0 +0,” namely Stage 0) is then stacked onto Stage 0 (the balance is 1) and the following movements are carried out (due to the fact that the value “1” was inserted into the stack):
   the value “1” is shifted from Stage 0 to Stage 1;
   the value “2” is shifted from Stage 1 to Stage 2;
   the value “3” is shifted from Stage 2 to Stage 3; and
   the value “4” is shifted from Stage 3 to the fifth stage of the stack, referenced as Stage 4.

It is noted that, at this moment t0+2, the reference element (“1”) is on Stage 1. At this same moment t0+2, an instruction “push 3” is generated;
at the moment t0+3, the instruction “push 3” is executed, the value “3” is then stacked onto Stage 0 (the balance is 1) and the following movements are carried out (due to the fact that the value “3” was pushed into the stack):
   the value “1” is shifted from Stage 0 to Stage 1;
   the value “1” is shifted from Stage 1 to Stage 2;
   the value “2” is shifted from Stage 2 to Stage 3;
   the value “3” is shifted from Stage 3 to Stage 4; and
   the value “4” is shifted from Stage 4 to the sixth stage of the stack, referenced as Stage 5.

It is noted that, at this moment t0+3, the reference element (“1”) is on Stage 2. At this same moment t0+3, an instruction “MUL32” is generated, corresponding to a multiplication of the values situated on Stages 1 and 0;
at the moment t0+4, the instruction “MUL32” is executed, the value “1” on Stage 1 is then multiplied by the value “3” on Stage 0, and the result of this multiplication, i.e., the value “3,” is stored on Stage 0 (the balance is −1). The following movements are then carried out (due to the fact that the values “1” and “3” were absorbed):
   the value “1” is shifted from Stage 2 to Stage 1;
   the value “2” is shifted from Stage 3 to Stage 2;
   the value “3” is shifted from Stage 4 to Stage 3; and
   the value “4” is shifted from Stage 5 to Stage 4.

It is noted that, at this moment t0+4, the reference element (“1”) is on Stage 1. At this same moment t0+4, an instruction “CELLREPL(x)” is generated. This instruction makes it possible to replace the element of the table stored on the Xth stage of the stack, in relation to the stage containing the reference element, by the element positioned at the bottom of the stack (Stage 0). As will be seen subsequently, for x=0 (CELLREPL(0)), the reference element is replaced by the element positioned at the bottom of the stack (Stage 0);
at the moment t0+5, the instruction “CELLREPL(0)” is executed, the value “1” on Stage 1 (i.e., the element stored on “Stage 1+0”) is replaced by the value “3” on Stage 0 (the balance is −1) and the following movements are carried out (due to the fact that the value “1” was absorbed):
   the value “2” is shifted from Stage 2 to Stage 1;
   the value “3” is shifted from Stage 3 to Stage 2; and
   the value “4” is shifted from Stage 4 to Stage 3.

It is important to note that, at this moment t0+5, the reference element is on Stage 0, namely the value “3.” At this same moment t0+5, an instruction “GETCELL(1)” is generated;
at the moment t0+6, the instruction “GETCELL(1)” is executed, the value “2” (i.e., the element stored on “Stage 0+1,” namely Stage 1) is then stacked onto Stage 0 (the balance is 1) and the following movements are carried out (due to the fact that the value “2” was inserted at the bottom of the stack):
   the value “3” is shifted from Stage 0 to Stage 1;
   the value “2” is shifted from Stage 1 to Stage 2;
   the value “3” is shifted from Stage 2 to Stage 3; and
   the value “4” is shifted from Stage 3 to Stage 4.

It is noted that, at this moment t0+6, the reference element (“3”) is on Stage 1. At this same moment t0+6, an instruction “push 3” is generated;
at the moment t0+7 the instruction “push 3” is executed, the value “3” is then stacked onto Stage 0 (the balance is 1) and the following movements are carried out (due to the fact that the value “3” was pushed into the stack):
   the value “2” is shifted from Stage 0 to Stage 1;
   the value “3” is shifted from Stage 1 to Stage 2;
   the value “2” is shifted from Stage 2 to Stage 3;
   the value “3” is shifted from Stage 3 to Stage 4; and
   the value “4” is shifted from Stage 4 to Stage 5.

It is noted that, at this moment t0+7, the reference element (“3”) is on Stage 2. At this same moment t07, an instruction “MUL32” is generated, corresponding to a multiplication of the values situated on Stages 1 and 0;
at the moment t0+8, the instruction “MUL32” is executed, the value “2”on Stage 1 is then multiplied by the value “3” on Stage 0, and the result of this multiplication, i.e., the value “6,” is stored on Stage 0 (the balance is −1). The following movements are then carried out (due to the fact that the values “2” and “3” were absorbed):
   the value “3” is shifted from Stage 2 to Stage 1;
   the value “2” is shifted from Stage 3 to Stage 2;
   the value “3” is shifted from Stage 4 to Stage 3; and
   the value “4” is shifted from Stage 5 to Stage 4.

It is noted that, at this moment t0+8, the reference element (“3”) is on Stage 1. At this same moment t0+8, an instruction “CELLREPL(1)” is generated;
at the moment t0+9, the instruction “CELLREPL(1)” is executed, the value “2” on Stage 2 (i.e., the element stored on “Stage 1+1”) is replaced by the value “6” on Stage 0 (the balance is −1) and the following movements are carried out (due to the fact that the value “2” was absorbed):
   the value “3” is shifted from Stage 1 to Stage 0;
   the value “6” is shifted from Stage 2 to Stage 1;
   the value “3” is shifted from Stage 3 to Stage 2; and
   the value “4” is shifted from Stage 4 to Stage 3.

It is important to note that, at this moment t0+9, the reference element is on Stage 0, namely the value “3.” At this same moment t0+9, an instruction “GETCELL(2)” is generated;
at the moment t0+10, the instruction “GETCELL(2)” is executed, the value “3” (i.e., the element stored on “Stage 0+2,” namely Stage 2) is then stacked onto Stage 0 (the balance is 1) and the following movements are carried out (due to the fact that the value “3” was inserted at the bottom of the stack);
   the value “3” is shifted from Stage 0 to Stage 1;
   the value “6” is shifted from Stage 1 to Stage 2;
   the value “3” is shifted from Stage 2 to Stage 3; and
   the value 4 is shifted from Stage 3 to Stage 4.

It is noted that, at this moment t0+10, the reference element (“3”) is on Stage 1. At this same moment t0+10, an instruction “push 3” is generated;
at the moment t0+11, the instruction “push 3” is executed, the value “3” is then stacked onto Stage 0 (the balance is 1) and the following movements are carried out (due to the fact that the value “3” was pushed into the stack):
   the value “3” is shifted from Stage 0 to Stage 1;
   the value “3” is shifted from Stage 1 to Stage 2;
   the value “6” is shifted from Stage 2 to Stage 3;
   the value “3” is shifted from Stage 3 to Stage 4; and
   the value “4” is shifted from Stage 4 to Stage 5.

It is noted that, at this moment t0+11, the reference element (“3”) is on Stage 2. At this same moment t0+11, an instruction “MUL32” is generated, corresponding to a multiplication of the values situated on Stages 1 and 0;
at the moment t0+12, the instruction “MUL32” is executed, the value “3” on Stage 1 is then multiplied by the value “3” on Stage 0, and the result of this multiplication, i.e., the value “9,” is stored on Stage 0 (the balance is −1). The following movements are then carried out (due to the fact that the values “3” and “3” were absorbed);
   the value “3” is shifted from Stage 2 to Stage 1;
   the value “6” is shifted from Stage 3 to Stage 2;
   the value “3” is shifted from Stage 4 to Stage 3; and
   the value “4” is shifted from Stage 5 to Stage 4.

It is noted that, at this moment t0+12, the reference element (“3”) is on Stage 1. At this same moment t0+12, an instruction “CELLREPL(2)” is generated;
at the moment t0+13, the instruction “CELLREPL(2)” is executed, the value “3” on Stage 3 (i.e., the element stored on “Stage 1 +2”) is replaced by the value “9” on Stage 0 (the balance is −1) and the following movements are carried out (due to the fact that the value “3” was absorbed):
   the value “3” is shifted from Stage 1 to Stage 0;
   the value “6” is shifted from Stage 2 to Stage 1;
   the value “9” is shifted from Stage 3 to Stage 2; and
   the value “4” is shifted from Stage 4 to Stage 3.

It is important to note that, at this moment t0+13, the reference element is on Stage 0, namely the value “3.” At this same moment t0+13, an instruction “GETCELL(3)” is generated;
at the moment t0+14, the instruction “GETCELL(3)” is executed, the value “4” (i.e., the element stored on “Stage 0 +3”) is then stacked onto Stage 0 (the balance is 1) and the following movements are carried out (due to the fact that the value “4” was inserted at the bottom of the stack):
   the value “3” is shifted from Stage 0 to Stage 1;
   the value “6” is shifted from Stage 1 to Stage 2;
   the value “9” is shifted from Stage 2 to Stage 3; and
   the value “4” is shifted from Stage 3 to Stage 4.

It is noted that, at this moment t0+14, the reference element (“3”) is on Stage 1. At this same moment t0+14, an instruction “push 3” is generated;
at the moment t0+15, the instruction “push 3” is executed, the value “3” is then stacked onto Stage 0 (the balance is 1) and the following movements are carried out (due to the fact that the value “3” was pushed into the stack):
   the value “4” is shifted from Stage 0 to Stage 1;
   the value “3” is shifted from Stage 1 to Stage 2;
   the value “6” is shifted from Stage 2 to Stage 3;
   the value “9” is shifted from Stage 3 to Stage 4; and
   the value “4” is shifted from Stage 4 to Stage 5.

It is noted that, at this moment t0+15, the reference element (“3”) is on Stage 2. At this same moment t0+15, an instruction “MUL32” is generated, corresponding to a multiplication of the values situated on Stages 1 and 0;
at the moment t0+16, the instruction “MUL32” is executed, the value “4” on Stage 1 is then multiplied by the value “3” on Stage 0, and the result of this multiplication, i.e., the value “12,” is stored on Stage 0 (the balance is −1). The following movements are then carried out (due to the fact that the values “4” and “3” were absorbed):
   the value “3” is shifted from Stage 2 to Stage 1;
   the value “6” is shifted from Stage 3 to Stage 2;
   the value “9” is shifted from Stage 4 to Stage 3; and
   the value “4” is shifted from Stage 5 to Stage 4.

It is noted that, at this moment t0+16, the reference element (“3”) is on Stage 1. At this same moment t0+16, an instruction “CELLREPL(3)” is generated;
at the moment t0+17, the instruction “CELLREPL(3)” is executed, the value “4” on Stage 4 (i.e., the element stored on “Stage 1 +3”) is replaced by the value “12” on Stage 0 (the balance is −1) and the following movements are carried out (due to the fact that the value “4” was absorbed):
   the value “3” is shifted from Stage 1 to Stage 0;
   the value “6” is shifted from Stage 2 to Stage 1;
   the value “9” is shifted from Stage 3 to Stage 2; and
   the value “12” is shifted from Stage 4 to Stage 3.

Thus, the result of the aforesaid matrix operation is the one-dimensional table “[3 6 9 12].”

FIG. 6 is an exemplary representation of the movement of the RAM memory plane and of the registers R1 and R2 of a processing device according to an embodiment of the invention.

The operation cycle (i.e., a series of instructions) is shown on the x-axis, and, on the y-axis, the following information:
STACKSIZE, indicating the current size of the stack (i.e., the number of elements in the stack at the current moment);
STACKPOINTER, indicating the current value of the stack pointer, i.e., the current physical address in the RAM memory plane of the first stage of the stack R1;
RAM @1 to RAM @high-5, representing the physical addresses of the RAM memory plane;
TR_TOGGLE, indicating the absolute access table on which work is being carried out at the current moment. It is important to note that, in the example of FIG. 6 (TR_TOGGLE=0), work is being carried out on the first absolute access table;
Tabroottg10_reg, indicating the current value of the absolute reference element pointer (for the first absolute access table), i.e., the current physical address in the RAM memory plane of the stage of the stack containing the absolute reference element. It is important to note that, in the example of FIG. 6 (Tabroottg10_reg=RAM @high-3), the stage of the stack containing the absolute reference element has the physical address of RAM @high-3 address;
TabRootPlusData, indicating the current value of the absolute reference. element pointer incremented by the number of units DataReg, i.e., the physical address in the RAM memory plane of the stage of the stack containing the DataRegth element of the first absolute access table, from the absolute reference element. It is important to note that, if the current instruction is not a table-handling instruction, in other words, if the current instruction is an arithmetic or data-handling instruction, then the value assumed by TabRootPlusData, referenced as DC (for “Don't Care”), is not important, in the sense that it is not involved during the execution of the current instruction;
R1 and R2, representing the first and second stages of the stack, respectively.

In this example, the matrix operation, already commented upon in relation to FIG. 5, is to be carried out, namely:

$$[ \begin{matrix}1 \\ 2 \\ 3 \\ 4\end{matrix} ] \times 3 = [ \begin{matrix}3 \\ 6 \\ 9 \\ 12\end{matrix} ]$$

For the sake of simplifying the description, the remainder of the description will be limited to describing the eight first instructions (of the operation cycle related to the aforesaid matrix operation) executed by the processing device according to an embodiment of the invention (hardware-implemented reverse Polish notation processing device). Those skilled in the art will easily extend this teaching to the other instructions of the operation cycle related to the aforesaid matrix operation.

As shown in FIG. 6, this matrix operation is translated by the following sequence: (it is assumed that at the moment tO, the first, second, third and fourth stages of the stack are loaded with the values “1,” “2,” “3” and “4,” respectively).
at the moment t0, an instruction “SETROOT” is generated. This instruction does not need the information TabRootPlusData (TabRootPlusData=DC) during its execution, due to the fact that this instruction is intended for table definition and not the handling of a table element. It is noted that, at this moment t0, the information STACKSIZE=4 and STACKPOINTER=RAM @high-3 indicate, respectively, that the stack contains four elements and that the first element of the stack is stored at the physical address RAM @high-3.
at the moment t0+1, the instruction “SETROOT” is executed (the balance on the stack is 0, STACKSIZE=4, there are four elements in the stack), the one-dimensional table “[1 2 3 4]” is then defined and has the element positioned at the address RAM @high-3 (Tabroottg10_reg=RAM @high-3) for its absolute reference element, i.e., the content of the first stage of the stack R1, namely the value “1.” As a matter of fact, at this moment, STACKPOINTER points to the address RAM @high-3. At this same moment t0+1, an instruction “GETCELL(0)” is generated. As will be seen below, this instruction makes it possible to insert, into the bottom of the stack (R1), the element of the table stored at the address RAM @high-3 (TabRootPlusData=RAM @high-3), namely the content of R1 “1.”
at the moment t0+2, the instruction “GETCELL(0)” is executed, the value “1” (i.e., the element stored (at t0+1) at the address RAM @high-3) is then stacked onto R1 (the balance on the stack is 1, STACKSIZE=5, there are five elements in the stack), the content of R1 “1” is shifted to R2, and the content of R2 “2” is shifted into the memory plane at the address RAM @high-2. The first and second stages of the stack R1 and R2 have for their physical address the addresses RAM @high-4 and RAM @high-3, respectively. As a matter of fact, at this moment, STACKPOINTER points to the address RAM @high-4. It is noted that the contents stored at the addresses RAM @1, @0, @high and @high-1 are not modified. At this same moment t0+2, a “push 3” instruction is generated. As already indicated, for an arithmetic instruction, TabRootPlusData=DC;
at the moment t0+3, the “push 3” instruction is executed, the value “3” is then stacked onto R1 (the balance on the stack is 1, STACKSIZE=6, there are six elements in the stack), the content R1 “1” is shifted to R2, and the content R2 “1” is shifted into the memory plane at the address RAM @high-3. The first and second stages of the stack R1 and R2 have for their physical address the addresses RAM (high-5 and RAM @high-4, respectively. As a matter of fact, at this moment, STACKPOINTER points to the address RAM @high-5. It is noted that the contents stored at the addresses RAM @1, @0, @high, @high-1 and @high-2 are not modified. At this same moment t0+3, an “MUL32” instruction is generated. As already indicated, for an arithmetic instruction, TabRootPlusData=DC;
at the moment t0+4, the instruction “MUL32” is executed, the content R2 “1” is then multiplied by the content of R1 “3,” and the result of this multiplication “3” is stored on R1. At this moment t0+4, STACKPOINTER points to the address RAM @high-4, the first and second stages of the stack R1 and R2 then have for their physical address the addresses RAM @high-4 and RAM @high-3, respectively. R2 being empty (its content having been absorbed), it is loaded with the content “1” stored at the address RAM @high-3 (the balance on the stack is −1, STACKSIZE=5). At this same moment t0+4, an instruction “CELLREPL(0)” is generated. As will be seen below, this instruction makes it possible to replace the element of the table stored at the address RAM @high-3 (TabRootPlusData=RAM @high-3), namely the content of R2 “1,” by the element positioned at the bottom of the stack, namely the content of R1 “3.”
at the moment t0+5, the instruction “CELLREPL(0)” is executed, the content of R2 “1” is then replaced by the content of R1 “3.”R1 being empty (its content having been shifted), the stack goes down again by one stage (the balance on the stack is −1, STACKSIZE=4) and R1 is loaded with the content of R2 “3.” At this moment t0+5, STACKPOINTER points to the address RAM @high-3, the first and second stages of the stack R1 and R2 then have for their physical address the addresses RAM @high-3 and RAM @high-2, respectively. R2 being empty (its content having fallen back down to the bottom of the stack (R1)), it is loaded with the content “2” stored at the address RAM @high-2. At this same moment t0+5, an instruction “GETCELL(1)” is generated. As will be seen below, this instruction makes it possible to insert, into the bottom of the stack (R1), the element of the table stored at the address RAM @high-2 (TabRootPlusData=RAM @high-2), namely the content of R2 “2.”
at the moment t0+6, the instruction GETCELL(1) is executed, the value “2” (i.e., the element stored at the address RAM @high-2) is then stacked onto R1 (the balance on the stack is 1, STACKSIZE=5), the content of R1 “3” is shifted to R2, and the content of R2 “2” is shifted into the memory plane at the address RAM @high-2. The first and second stages of the stack R1 and R2 have for their physical address the addresses RAM @high-4 and RAM @high-3, respectively. As a matter of fact, at this moment, STACKPOINTER points to the address RAM @high-4. At this same moment t0+6, an instruction “push 3” is generated. As already indicated, for an arithmetic instruction, TabRootPlusData=DC;
at the moment t0+7, the instruction “push 3” is executed, the value “3” is then stacked onto R1 (the balance on the stack is 1, STACKSIZE=6), the content of R1 “2” is shifted to R2, and the content of R2 “3” is shifted into the memory plane at the address RAM @high-3. The first and second stages of the stack R1 and R2 have for their physical address the addresses RAM @high-5 and RAM @high-4, respectively. As a matter of fact, at this moment, STACKPOINTER points to the address RAM @high-5. At this same moment t0+7, an instruction “MUL32” is generated. As already indicated, for an arithmetic instruction, TabRootPlusData=DC.

APPENDIX 1: Table-handling Instructions

The table below summarizes the various table-handling instructions. The first column of the table identifies the name of the instruction, the second column specifies the argument (operand), the third one describes the arithmetic operation to be carried out and the last one indicates the balance on the stack.

HANDLING OF TABLES

| | | | |
|---|---|---|---|
| SETROOT | none | if TR_TOGGLE=0 then | 0 |
| | | TABROOTTGL0_reg <= SP | |
| | | else | |
| | | TABROOTTGL1_reg <= SP | |
| ROOTTOGGLE | none | TR_TOGGLE <= !TR_TOGGLE | 0 |
| | | initial value is 0 | |
| CELLREPL(x) | 12 | if TR_TOGGLE=0 then | −1 |
| | bits | S(TABROOTTGL0_reg+x)<=S0 | |
| | | else | |
| | | S(TABROOTTGL1_reg+x)<=S0 | |
| | | end | |
| | | drops data | |
| GETCELL(x) | 12 | if TR_TOGGLE=0 then | 1 |
| | bits | inserts S(TABROOTTGL0_reg+x) | |
| | | else | |
| | | inserts S(TABROOTTGL1_reg+x) | |
| GETCELLREL(x) | 4 | if TPC_TOGGLE=0 then | 1 |
| | bits | S0<=S(TabPreviousCellTGL0_reg+x) | |
| | | else | |
| | | S0<=S(TabPreviousCellTGL1_reg+x) | |
| GCRTOGGLE | none | TPC_TOGGLE<=!TPC_TOGGLE | 0 |
| | | initial value is 0 | |

For the sake of clarity in the remainder of the description, as concerns the instructions SETROOT, ROOTTOGGLE, GETCELL(X) and GCRTOGGLE, the role of each instruction is clearly identified and its hardware implementation is specified, i.e., the state or action carried out by each means M0 to M27 of the processing device according to an embodiment of the invention is indicated. It is recalled that the instructions CELLREPL(X) and GETCELLREL(X) are described in paragraph 6.4 of this document.

1. Instruction SETROOT

This instruction makes it possible to modify the current value of the absolute reference element pointer, with a balance of 0 on the stack.

This instruction SETROOT is translated by the following sequence:

M0: decode the instruction;

M20: if TR_TOGGLE=0 then
TABROOTTGL0_reg<=StackPointer
otherwise
TABROOTTGL1_reg<=StackPointer;

Let TABROOTTGLO_reg and TABROOTTGL1_reg be two registers each capable of having a physical address in the stack. In a preferred embodiment, a single-bit register TR_TOGGLE is used, making it possible to manage two absolute access tables by selecting either of the two aforesaid registers, in the following way: if TR_TOGGLE equals “0,” then the register R3 (Tabroottg10_reg) assumes the value of the stack pointer (StackPointer), on the other hand, if TR_TOGGLE equals “1,” then the register R4 (Tabroottg11_reg) assumes this value;

M23: selects the output corresponding to the value of the stack pointer (StackPointer);

M22: if TR_TOGGLE=0 then
TabPreviousCellTGL0_reg<=StackPointer
otherwise
TabPreviousCellTGL1_reg<=StackPointer;

Let TabPreviousCellTGL0_reg and TabPreviousCellTGL0_reg be two registers each capable of having a physical address of the stack. In a preferred embodiment, a single-bit register TR_TOGGLE is used, making it possible to manage two absolute access table by selecting either of the two aforesaid registers, in the following way: if TR_TOGGLE equals “0,” then the register R6 (TabPreviousCellTg10_reg) assumes the value of the stack pointer (StackPointer), on the other hand, if TR_TOGGLE equals “1,” then the register R7 (TabPreviousCellTg11_reg) assumes this value.

2. Instruction ROOTTOGGLE

This instruction makes it possible to change tables, with a balance of 0 on the stack. More precisely, this instruction makes it possible to select one table from among two tables by selecting the current value of an absolute reference element pointer from among two possible values.

This instruction ROOTTOGGLE is translated by the following sequence:

M0: decodes the instruction;

M24: TR_TOGGLE<=not TR_TOGGLE M24 changes the state of the register R5 (belonging to the first means for selecting M24 one table from among the two absolute access tables):
if the output of R5 is at “1,” then M24 positions the output at “0”;
on the other hand, if the output of R5 is at “0,” then M24 positions the output at “1.”
   3. Instruction GETCELL(X)

This instruction makes it possible to insert, into the first stage of the stack, the Xth element of a table, in relation to an absolute reference element, with a balance of 1 on the stack.

This instruction GETCELL(X) is translated by the following sequence:

M0: decodes the instruction;

M4: quiescent state (no arithmetic operation, the ALU is not selected);

M7: selects the output of the means for compensating for the sides effects of the cache, named GetCellRelOut;

M1: selects the input corresponding to StackPointer−1 (balance +1 on the stack);

M2: re-updates at the next clock stroke, if the enable input of the register is at “1” (NextInstrAck=1);

M5: selects the input corresponding to the output of the means M20 for determining the physical address of the DataRegth cell of the table selected by TabRootTgl: TabRootTglx_reg+DataReg;

M20: calculates the physical address of the DataRegth cell of the table selected by TR_TOGGLE;

M6: selects the input StackPointer+1, the physical cell corresponding to Stage 1 in the memory plane must be updated with the data ValR2 of the register R2, which will itself be updated with the former value ValR1 of the register R1;

M9: quiescent state;

M0: positions the memory enable “Me” and write enable “We” inputs of M3 at “1,” thus, there will be a reading at the address selected by M5 and a writing at the address selected by M6;

M8: selects the input ValR1 (R1);

M21: the input multiplexer of the comparators selects TabRootPlusData;

M27:
if the equality comparator at “StackPointer” of M21 presents “1” at its output, then M27 selects the input ValR1 (R1);
if the equality comparator at “StackPointer+1” of M21 presents “1” at its output, then M27 selects the input ValR2 (R2);
if none of the equality comparators at “StackPointer” and at “StackPointer+1” are at “1”, then M27 selects the input SMDout;
   4. Instruction GCRTOGGLE

This instruction makes it possible to change the pointer TabPreviousCellGLX_reg. More precisely, this instruction makes it possible to select one table from among two tables by selecting the current value of a relative reference element pointer from among two possible values, with a balance of 0 on the stack.

This instruction GCRTOGGLE is translated by the following sequence:

M0: decodes the instruction;

M25: TPC_TOGGLE<=not TPC_TOGGLE;

M25 changes the state of the register R8 (belonging to the second means of selecting M25 one table from among the two relative access tables):
if the output R8 is at “1,” then M25 positions the output at “O”;

on the other hand, if the output of R8 is at “O,” then M25 positions the output at “1.”

APPENDIX 2
Example of a matrix operation program written in C language

```
func_mul_matrix22_by_cst(unsigned char coeff) {
SETROOT( );
  for(i=0; i<2; i++) {
  for(j=0;j<2;j++) {
  GETCELL(i*2+j);
  PUSHD(coeff);
  MUL32( );
  CELLREPL(i*2+j)
  }
  }
  }
```

At least one embodiment of this disclosure provides provide a reverse Polish notation processing device that is simple to implement with hardware and well-suited to handling data tables.

The disclosure also proposes such a processing device which, in at least one embodiment, is particularly well-suited to the decoding of MP3/WMA-type audio streams.

The disclosure proposes such a processing device which, in on particular embodiment, is inexpensive, particularly in terms of resources.

The disclosure proposes such a processing device, which, in one particular embodiment, does not require any software overlay.

The disclosure such a processing device which, in one particular embodiment, is efficient, particularly in terms of electricity consumption.

Although the present disclosure has been described with reference to one or more embodiments, workers skilled in the art will recognize that changes may be made in form and detail without departing from the spirit and scope of the disclosure.

What is claimed is:

1. Reverse Polish notation processing device making it possible to execute a set of instructions and implementing management of a stack whose size is variable, the device comprising:
a storage device including a random access memory;
a stack pointer managing device, which manages a stack pointer, which is a physical address, in said random access memory, associated with a reference stage of the stack, each stage of the stack being such that when the stack moves it occupies a fixed position in the stack but is associated with a physical address in said random access memory, which varies;
a reference element pointer managing device, which manages at least one reference element pointer, which is a physical address, in said random access memory, associated with one reference element among elements of a given table contained in the stack, said reference element being such that when the stack moves it can be located at different stages of the stack but is associated with a physical address that does not vary,
such that the processing device can execute at least one table handling instruction with respect to said at least one reference element pointer.

2. Device of claim 1, said reference element pointer managing device includes a device that manages an absolute reference element pointer, which is a physical address, in said random access memory, associated with an absolute reference element among the elements of a given table contained in the stack.

3. Device as claimed in claim 1, wherein the reference element pointer managing device includes a device that manages a relative reference element pointer, which is a physical address, in said random access memory, associated with one relative reference element among the elements of a given table contained in the stack.

4. Device as claimed in claim 1, wherein for each reference element pointer, said reference element pointer managing device includes at least one register containing the current value of said reference element pointer for a given table.

5. Device as claimed in claim 2, wherein said device for managing an absolute reference element pointer includes at least one first register containing the current value of said absolute reference element pointer for a given table, the input of each first register receiving the current value of said stack pointer, each first register being activated by an activation signal assuming an active state when the current instruction is an instruction involving a change in the absolute reference element for said given table.

6. Device as claimed in claim 3, wherein said device for managing a relative reference element pointer includes at least one second register containing the current value of said relative reference element pointer for a given table, the input of each second register receiving one of the following signals based on the current instruction:
the current value of said stack pointer,
the current value of an absolute reference element pointer for a given table, incremented by a number X of units indicated in an operand word of a current instruction,
the current value of a relative reference element pointer for a given table, incremented by a number X of units indicated in an operand word of a current instruction, each second register being activated by an activation signal assuming an active state when the current instruction is an instruction involving a change in the relative reference element for said given table.

7. Device as claimed in claim 4, wherein, for each reference element pointer, said reference element pointer managing device includes:
at least two first or second registers each containing the current value of said reference element pointer for a given table;
a selector, which selects one of said at least two first or second registers, so as to select one table among at least two tables.

8. Device as claimed in claim 2, wherein said device for managing an absolute reference element pointer includes an adder, which adds the current value of said absolute reference element pointer for a given table to a number X of units indicated in an operand word of a current instruction, so as to determine, from said absolute reference element, the physical address, in said random access memory, of a stage of the stack whose content is the Xth element of said given table.

9. Device as claimed in claim 3, wherein said device for managing a relative reference element pointer includes an adder, which adds the current value of said relative reference element pointer for a given table to a number X of units indicated in an operand word of a current instruction, so as to determine, from said relative reference element, the physical address, in said random access memory, of a stage of the stack whose content is the Xth element of said given table.

10. Device as claimed in claim 1, the set of instructions being such that each instruction includes a maximum of N operands, with N>1, wherein said storage device further includes a cache memory, and said processing device further includes one or more devices that manage the contents of the stages of the stack, with relation to said stack pointer:
such that, for each of the N first stages of the stack, the content of said stage is stored in said cache memory, and for each of the other stages of the stack, the content of said stage is stored in said random access memory, at the physical address associated with said stage;
making it possible for the one or more devices that manage the contents to manage content overflows from the cache memory towards the random access memory, and vice-versa.

11. Device of claim 10, wherein N is equal to 2.

12. Device as claimed in claim 1, wherein the processing device is included in a co-processor intended to cooperate with a main processor.

13. Device as claimed in claim 1, wherein said reference stage of the stack is the first stage of the stack.

14. Device as claimed in claim 1, wherein the stack pointer managing device includes:
a first multiplexer (M1):
having three inputs receiving, respectively: a current value of the stack pointer, said current value of the stack pointer incremented by one unit, and said current value of the stack pointer decremented by one unit
delivering at its output one of the three input values of a current instruction, on the basis of a first control signal taking into account the balance on the stack, +1, −1 or 0;
a third register containing said current value of said stack pointer, the input of said third register being connected to the output of said first multiplexer, said third register being activated by an activation signal indicating that a next instruction is ready.

15. Device as claimed in claim 10, wherein said one or more devices for managing the contents of the stages of the stack include a device for determining the next write address in said random access memory, including:
a second multiplexer:
having a plurality of inputs each receiving a current value of the stack pointer incremented or decremented by a specific value that is separate for each input;
delivering at its output one of the input values, on the basis of a second control signal which is based on a current instruction,
and wherein said plurality of inputs of the second multiplexer includes at least one of the two following inputs:
an input receiving the current value of an absolute reference element pointer for a given table, incremented by a number X of units indicated in an operand word of a current instruction;
an input receiving the current value of a relative reference element pointer for a given table, incremented by a number X of units indicated in an operand word of a current instruction.

16. Device as claimed in claim 10, wherein said one or more devices for managing the contents of the stages of the stack includes a device for determining the next read address in said random access memory, themselves including:
a third multiplexer:
having a plurality of inputs each receiving a current value of the stack pointer incremented or decremented by a specific value that is separate for each input;
delivering at its output one of the input values, on the basis of a third control signal, which is based on a current instruction,
and wherein said plurality of inputs of the third multiplexer include at least one of the following two inputs:
an input receiving the current value of an absolute reference element pointer for a given table, incremented by a number X of units indicated in an operand word of a current instruction;
an input receiving the current value of a relative reference element pointer for a given table, incremented by a number X of units indicated in an operand word of a current instruction.

17. Device as claimed in claim 15, wherein said plurality of inputs of the second multiplexer further includes at least one input belonging to the group including:
an input receiving said current value of the stack pointer incremented by a number of units (DataReg) indicated in an operand word of said current instruction;
an input receiving said current value of the stack pointer incremented by one unit;
an input receiving said current value of the stack pointer incremented by two units;
an input receiving said current value of the stack pointer decremented by one unit.

18. Device as claimed in claim 10, wherein said one or more devices for managing the contents of the stages of the stack includes a device for determining the side effects of the cache memory, including:
a first comparator, making it possible to make a comparison, on the one hand, between the current value of a reference element pointer incremented by a number X of units indicated in an operand word of a current instruction, and, on the other hand, the current value of the stack pointer;
a second comparator, making it possible to make a comparison, on the one hand, between the current value of a reference element pointer incremented by a number X of units indicated in an operand word of a current instruction, and, on the other hand, the current value of the stack pointer incremented by one unit,
so as to determine if the current value of the reference element pointer incremented by the number X of units is a physical address, in said random access memory, associated with a stage of the stack whose content is stored in the random access memory or in the cache memory.

19. Device of claim 18, wherein the device for determining the side effects of the cache memory further includes:
a third comparator, making it possible to make a comparison, on the one hand, between the current value of a reference element pointer incremented by a number X of units indicated in an operand word of a current instruction, and, on the other hand, the current value of the stack pointer incremented by two units;
so as to determine if the current value of the reference element pointer incremented by the number X of units is a physical address, in said random access memory, associated with the N+1 stage of the stack whose content is stored in the random access memory (RAM).

20. Device as claimed in claim 18, wherein said device for determining the side effects of the cache memory further includes:
a fifth multiplexer:
having two inputs receiving, respectively:
the current value of the absolute reference element pointer for a given table, incremented by a number X of units indicated in an operand word of a current instruction;
the current value of a relative reference element pointer for a given table, incremented by a number X of units indicated in an operand word of a current instruction;
delivering at its output one of the input values, on the basis of a fifth control signal.

21. Device as claimed in claim 18, wherein said one or more devices for managing the contents of the stages of the stack include a device for determining the next value to be written in said cache memory for the content of the first stage, including:
a sixth multiplexer:
having a plurality of inputs each receiving a separate specific value, said plurality of inputs including:
an input receiving the current value of the content of the first stage;
an input receiving the current value of the content of the second stage;
an input receiving a value delivered by a device for compensating for the side effects of the cache memory;
delivering at its output one of the input values, on the basis of at least one of:
a sixth control signal, which is based on a current instruction, or
a seventh control signal, delivered by said device for determining the side effects of the cache memory, which indicates if the current value of the reference element pointer incremented by the number X of units is equal to the current value of the stack pointer incremented by one unit:
and wherein said cache memory includes a fourth register containing a current value of the content of the first stage, the input of said fourth register being connected to the output of said sixth multiplexer, said fourth register being activated by an activation signal indicating that a next instruction is ready.

22. Device of claim 21, wherein said plurality of inputs of the sixth multiplexer further includes at least one input belonging to the group including:
an input receiving a value indicated in an operand word of said current instruction;
an input receiving data read in the random access memory during the execution of a current instruction;
an input receiving data calculated during the execution of a current instruction.

23. Device as claimed in claim 18, wherein said one or more devices for managing the contents of the stages of the stack include a device for determining the next value to be written in said cache memory for the content of the second stage, including:
a seventh multiplexer:
having a plurality of inputs each receiving a separate specific value, said plurality of inputs including:
an input receiving the current value of the content of the first stage;
an input receiving the current value of the content of the second stage;
an input receiving data read in the random access memory during the execution of a current instruction;
delivering at its output one of the input values, on the basis of at least one of:
an eight control signal, which is based on a current instruction; or
a seventh control signal, delivered by said device for determining the side effects of the cache memory, which indicates if the current value of the reference element pointer incremented by the number X of units is equal to the current value of the stack pointer incremented by one unit; or
a ninth control signal, delivered by said device for determining the side effects of the cache memory, and which indicates if the current value of the reference element pointer incremented by the number X of units is equal to the current value of the stack pointer incremented by two units;
and wherein said cache memory includes a fifth register containing a current value of the content of the second stage, the input of said fifth register being connected to the output of said seventh multiplexer, said fifth register being activated by an activation signal indicating that a next instruction is ready.

24. Device as claimed in claim 10, wherein said one or more devices for managing the contents of the stages of the stack include a device for compensating for the side effects of the cache memory, including:
an eighth multiplexer:
having the following inputs:
an input receiving the current value of the content of the first stage;
an input receiving the current value of the second stage;
an input receiving data read in the random access memory during the execution of a current instruction;
delivering at its output one of the input values, on the basis of seventh and tenth control signals, delivered by said device for determining the side effects of the cache memory, such that the output delivers:
the current value of the content of the first stage, if the tenth control signal indicates that the current value of the reference element pointer incremented by the number X of units is equal to the current value of the stack pointer;
the current value of the content of the second stage, if the seventh control signal indicates that the current value of the reference element pointer incremented by the number X of units is equal to the current value of the stack pointer incremented by one unit;
the data read in the random access memory during the execution of a current instruction, if the seventh and tenth control signals together indicate that the current value of the reference element pointer incremented by the number X of units is equal to the current value of the stack pointer incremented by more than one unit.

25. Device as claimed in claim 14 each control signal is delivered by an instruction decoder that processes said current instruction contained in an instruction register.

26. Device as claimed in claim 1 said set of instructions includes at least one table handling instruction belonging to the group including:
an instruction making it possible to modify the current value of an absolute reference element pointer;
an instruction making it possible to select one table among two tables by selecting the current value of an absolute reference element pointer from among two possible values;
an instruction making it possible to replace the Xth element of a table, in relation to an absolute reference element, with an element contained in the first stage of the stack, said element contained in the first stage of the stack being absorbed;
an instruction making it possible to insert the Xth element of a table into the first stage of the stack, in relation to an absolute reference element;
an instruction making it possible to insert the Xth element of a table into the first stage of the stack, in relation to a relative reference element;
an instruction making it possible to select one table between two tables by selecting the current value of a relative reference element pointer from among two possible values.

27. An electronic integrated circuit comprising a Reverse Polish notation processing device making it possible to execute a set of instructions and implementing management of a stack whose size is variable, the processing device comprising:
a storage device including a random access memory;
a stack pointer managing device, which manages a stack pointer, which is a physical address, in said random access memory, associated with a reference stage of the stack, each stage of the stack being such that when the stack moves it occupies a fixed position in the stack but is associated with a physical address in said random access memory, which varies;
a reference element pointer managing device, which manages at least one reference element pointer, which is a physical address, in said random access memory, associated with one reference element among elements of a given table contained in the stack, said reference element being such that when the stack moves it can be located at different stages of the stack but is associated with a physical address that does not vary, such that the processing device can execute at least one table handling instruction with respect to said at least one reference element pointer.
